(19) United States
(12) Patent Application Publication
(10) Pub. No.: US 2022/0215228 A1
(43) Pub. Date: Jul. 7, 2022

(54) DETECTION METHOD, COMPUTER-READABLE RECORDING MEDIUM STORING DETECTION PROGRAM, AND DETECTION DEVICE

(71) Applicant: FUJITSU LIMITED, Kawasaki-shi (JP)

(72) Inventor: Yasuto Yokota, Kawasaki (JP)

(73) Assignee: FUJITSU LIMITED, Kawasaki-shi (JP)

(21) Appl. No.: 17/706,369

(22) Filed: Mar. 28, 2022

Related U.S. Application Data
(63) Continuation of application No. PCT/JP2019/041580, filed on Oct. 23, 2019.

(51) Int. Cl. G06N 3/04; G06V 10/771; G06V 10/764; G06V 10/82

(52) U.S. Cl. CPC G06N 3/04; G06V 10/82; G06V 10/764; G06V 10/771

(57) ABSTRACT

A computer-implemented detection method including: specifying, from a first image, an area that contributed to calculation of one of scores for a first class among the scores for each class obtained by inputting the first image to a deep learning model; generating a second image in which the area other than the area specified by the specifying is masked in the first image; and acquiring the scores obtained by inputting the second image to the deep learning model.

### CROSS-REFERENCE TO RELATED APPLICATION

This application is a continuation application of International Application PCT/JP2019/041580 filed on Oct. 23, 2019 and designated the U.S., the entire contents of which are incorporated herein by reference.

### FIELD

The embodiments discussed herein are related to a detection method, a detection program, and a detection device.

### BACKGROUND

In recent years, the introduction of deep learning models into image data determination and classification functions and the like has been progressing in information systems used by companies and the like. Since the deep learning model is configured to determine and classify in line with teacher data learned at the time of development, when the teacher data is biased, there is a possibility that a result not intended by a user will be output. In response to this, an approach for detecting bias in the teacher data has been proposed.

Examples of the related art include as follows: R. R. Selvaraju, M. Cogswell, A. Das, R. Vedantam, D. Parikh, and D. Batra, “Grad-CAM: Visual Explanations from Deep Networks via Gradient-based Localization”, in Proc. IEEE Int. Conf. On Computer Vision (ICCV), 2017 (https://arxiv.org/abs/1610.02391).

### SUMMARY

According to an aspect of the embodiments, there is provided a computer-implemented detection method including: specifying, from a first image, an area that contributed to calculation of one of scores for a first class among the scores for each class obtained by inputting the first image to a deep learning model; generating a second image in which the area other than the area specified by the specifying is masked in the first image; and acquiring the scores obtained by inputting the second image to the deep learning model.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating a configuration example of a detection device of a first embodiment;

FIG. 2 is a diagram for explaining data bias;

FIG. 3 is a diagram for explaining a method of generating a mask image;

FIG. 4 is a diagram illustrating examples of a heat map;

FIG. 5 is a diagram for explaining a method of detecting data bias;

FIG. 6 is a diagram illustrating an example of detection results;

FIG. 7 is a flowchart illustrating a processing flow of the detection device; and

FIG. 8 is a diagram explaining a hardware configuration example.

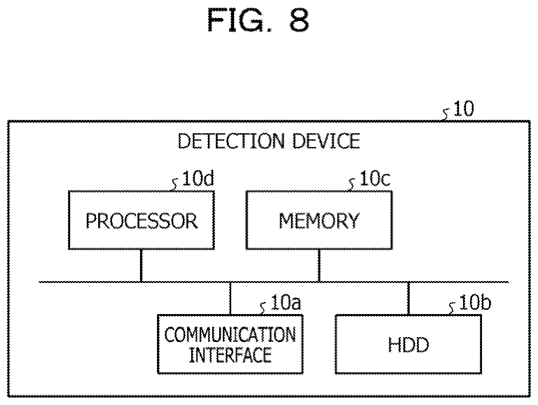

### DESCRIPTION OF EMBODIMENTS

However, the prior approach has a disadvantage that a huge amount of man-hours is sometimes involved to detect bias in the teacher data. For example, the prior gradient-weighted class activation mapping (Grad-CAM) outputs an area in an image that contributed to the classification into a certain class and the contribution, as a heat map. At this time, the user manually checks the output heat map and examines whether the area having a high contribution is as intended by the user. For this reason, when the deep learning model is configured to classify into 1,000 classes, for example, the user will have to manually check 1,000 heat maps for one image, which leads to a huge amount of man-hours.

One aspect aims to detect bias in teacher data with a small number of man-hours.

Hereinafter, embodiments of a detection method, a detection program, and a detection device will be described in detail with reference to the drawings. Note that these embodiments do not limit the present disclosure. Furthermore, the embodiments may be appropriately combined with each other within a range without inconsistency.

### First Embodiment

[Functional Configuration]

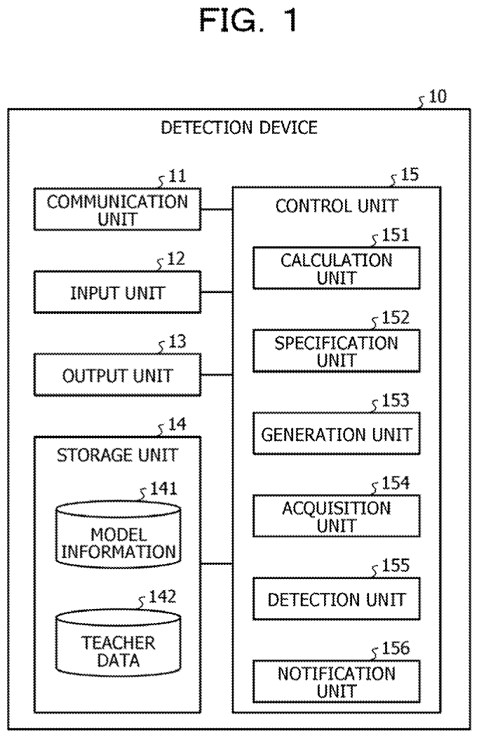

A configuration of a detection device according to an embodiment will be described with reference to FIG. 1. FIG. 1 is a diagram illustrating a configuration example of the detection device of the first embodiment. As illustrated in FIG. 1, the detection device 10 includes a communication unit 11, an input unit 12, an output unit 13, a storage unit 14, and a control unit 15.

The communication unit 11 is an interface for communicating data with other devices. For example, the communication unit 11 is a network interface card (NIC) and may also be configured to communicate data via the Internet.

The input unit 12 is an interface for accepting input of data. For example, the input unit 12 may also be an input device such as a keyboard or a mouse. In addition, the output unit 13 is an interface for outputting data. The output unit 13 may also be an output device such as a display or a speaker. Furthermore, the input unit 12 and the output unit 13 may also be configured to input and output data from and to an external storage device such as a universal serial bus (USB) memory.

The storage unit 14 is an example of a storage device that stores data and a program and the like executed by the control unit 15 and, for example, is a hard disk, a memory, or the like. The storage unit 14 stores model information 141 and teacher data 142.

The model information 141 is information for constructing a model, such as parameters. In the present embodiment, the model is assumed to be a deep learning model that classifies images into classes. The deep learning model calculates a predefined score for each class on the basis of the feature of an image that has been input. The model information 141 includes, for example, weights and biases of each layer of a deep neural network (DNN).

The teacher data 142 is a set of images used for learning (training) of the deep learning model. In addition, it is assumed that the images included in the teacher data 142 are assigned with labels for learning. The images may also be assigned with labels corresponding to what is recognizable to a person when looking at the corresponding images. For example, when the fact that a cat is shown is recognizable to a person when looking at an image, the corresponding image is assigned with a label of “cat”. Note that attention will be paid that learning of the model can be referred to as training of the model. For example, in the learning process for the deep learning model, the deep learning model is trained using the teacher data.

The control unit 15 is implemented, for example, by a central processing unit (CPU), a micro processing unit (MPU), a graphics processing unit (GPU), or the like executing a program stored in an internal storage device with a random access memory (RAM) as a working area. In addition, the control unit 15 may also be implemented, for example, by an integrated circuit such as an application specific integrated circuit (ASIC) or a field programmable gate array (FPGA). The control unit 15 includes a calculation unit 151, a specification unit 152, a generation unit 153, an acquisition unit 154, a detection unit 155, and a notification unit 156.

Hereinafter, the operation of each unit of the control unit 15 will be described along with a flow of processing by the detection device 10. The detection device 10 performs a process of generating a mask image from an input image and a process of detecting a class in which the teacher data is biased on the basis of the mask image. In addition, bias in the teacher data will be sometimes referred to as data bias.

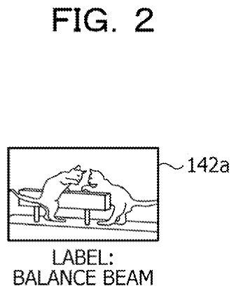

FIG. 2 is a diagram for explaining the data bias. An image 142a in FIG. 2 is an example of an image included in the teacher data 142. The image 142a shows a balance beam and two cats. In addition, the image 142a is assigned with the label “balance beam”. Furthermore, it is assumed that both of the “balance beam” and the “cat” are included in classes targeted for classification by the deep learning model.

Here, at the time of learning of the deep learning model, the information that the label of the image 142a is the “balance beam” is only given. Therefore, the deep learning model will recognize even the feature of an area of the image 142a where the cats are shown, as the feature of the balance beam. In such a case, the “balance beam” class can be deemed to be a class having data bias.

(Process of Generating Mask Image)

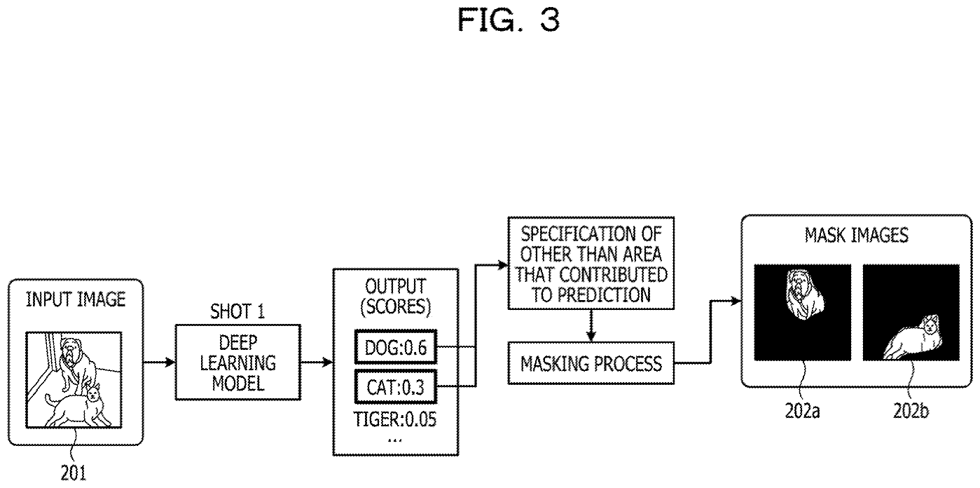

FIG. 3 is a diagram for explaining a method of generating a mask image. First, the calculation unit 151 inputs an input image 201 to the deep learning model and calculates a score (shot 1). The input image 201 shows a dog and a cat. Meanwhile, the balance beam is not shown in the input image 201. Note that the input image 201 is an example of a first image.

Here, when learning of the deep learning model is performed using the image 142a in FIG. 2, it is considered that data bias occurs in the “balance beam” class. In that case, it is considered that the deep learning model calculates the score of the “balance beam” class to be higher because of the feature of the area in which the cat is shown in the input image 201. Conversely, at this time, the deep learning model is supposed to calculate the score of the “cat” class to be lower than the user expected. In this manner, the data bias causes a deterioration in the function of the deep learning model.

The specification unit 152 specifies, from the input image 201, an area that contributed to the calculation of the score of a first class among scores for each class obtained by inputting the input image 201 to the deep learning model. For example, the detection unit 155 detects a second class that is different from the first class and whose score acquired by the acquisition unit 154 is equal to or higher than a first threshold value.

In the example in FIG. 3, the specification unit 152 specifies areas that contributed to the calculation of the scores of the “dog” class and the “cat” class whose scores for each class obtained by inputting the input image 201 to the deep learning model are equal to or higher than, for example, 0.3. The numerical value 0.3 is an example of a second threshold value. In addition, the scores of the “dog” class and the “cat” class are examples of the first class. Furthermore, in the following description, the first class will be sometimes referred to as a prediction class.

Here, the specification unit 152 can specify the area that contributed to the calculation of the score of each class on the basis of the contribution obtained by Grad-CAM (for example, refer to “Grad-CAM: Visual Explanations from Deep Networks via Gradient-based Localization”). When Grad-CAM is executed, the specification unit 152 first calculates the loss of the target class and then calculates each channel weight by performing the back propagation to a convolutional layer closest to the output layer. Next, the specification unit 152 multiplies the output of the forward propagation of the convolutional layer by the calculated weight for each channel to specify the area that contributed to the prediction of the target class.

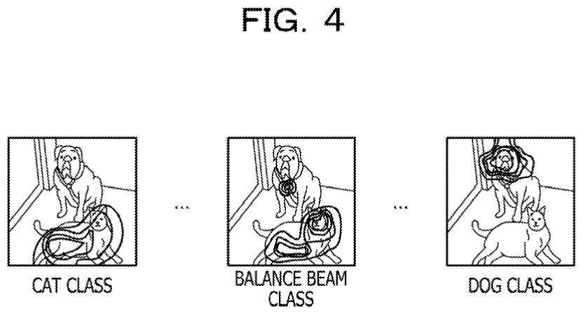

The area specified by Grad-CAM is represented by a heat map as illustrated in FIG. 4. FIG. 4 is a diagram illustrating examples of the heat map. As illustrated in FIG. 4, the score of the “dog” class and the score of the “cat” class are calculated on the basis of the feature of the area where the dog is shown and the feature of the area where the cat is shown, respectively. Meanwhile, the score of not only the “cat” class but also the “balance beam” class is calculated from the feature of the area where the cat is shown.

Returning to FIG. 3, the generation unit 153 generates a mask image in which an area other than the area specified by the specification unit 152 is masked in the input image 201. For example, the generation unit 153 further specifies a second area other than a first area specified by the specification unit 152 in the input image 201 and generates a mask image in which the second area is masked. The generation unit 153 generates a mask image 202a for the “dog” class and a mask image 202b for the “cat” class.

In addition, for example, by making the pixel values of pixels in an area other than the area specified by the specification unit 152 the same, the generation unit 153 can mask the corresponding area. For example, the generation unit 153 performs a masking process by coloring pixels in the area to be masked in a single color of black or white.

(Process of Detecting Class Having Data Bias)

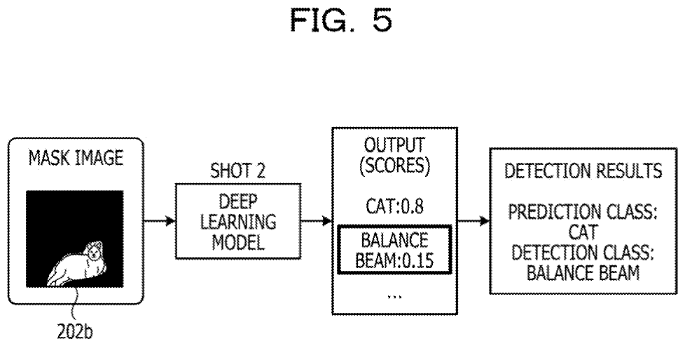

A method of detecting a class having data bias that is affecting the “cat” class will be described with reference to FIG. 5. FIG. 5 is a diagram for explaining a method of detecting data bias. The calculation unit 151 inputs the mask image 202b for the “cat” class to the deep learning model and calculates the score (shot 2). The acquisition unit 154 acquires the scores obtained by inputting the mask image to the deep learning model.

The detection unit 155 detects the second class which is a class different from the first class and whose score acquired by the acquisition unit 154 is equal to or higher than the first threshold value. In the example in FIG. 5, the detection unit 155 detects the “balance beam” class, which is a class different from the “cat” class and whose score acquired by the acquisition unit 154 is equal to or higher than, for example, 0.1, as a class having data bias. The numerical value 0.1 is an example of the first threshold value.

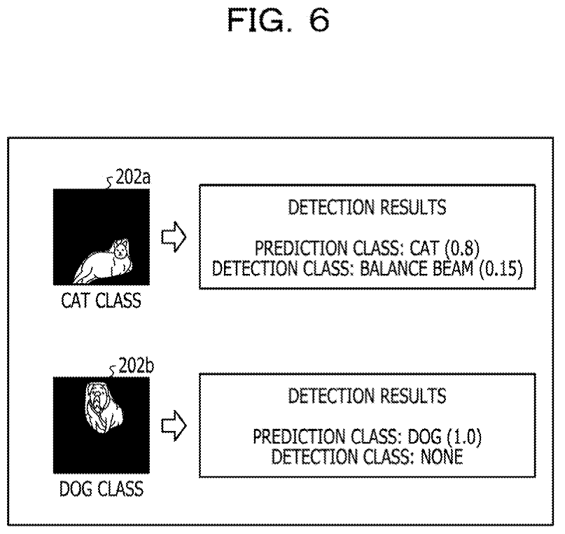

The notification unit 156 makes a notification of the class having data bias, which has been detected by the detection unit 155, via the output unit 13. As illustrated in FIG. 6, the notification unit 156 may also display a screen indicating the detection results on the output unit 13 together with the mask images for each class. FIG. 6 is a diagram illustrating an example of detection results. The screen in FIG. 6 indicates that the “balance beam” class having data bias degrades the prediction accuracy of the “cat” class. In addition, the screen in FIG. 6 indicates that no degradation in the prediction accuracy of the “dog” class due to data bias has occurred.

In addition, the notification unit 156 may also extract an image of a class having data bias from the teacher data 142 and present the extracted image to the user. For example, when the detection unit 155 detects the “balance beam” class as a class having data bias, the notification unit 156 presents the image 142a assigned with the label “balance beam” to the user.

The user can exclude the presented image 142a from the teacher data 142 and add another image assigned with the “balance beam” label to the teacher data 142 as appropriate to perform relearning of the deep learning model.

[Processing Flow]

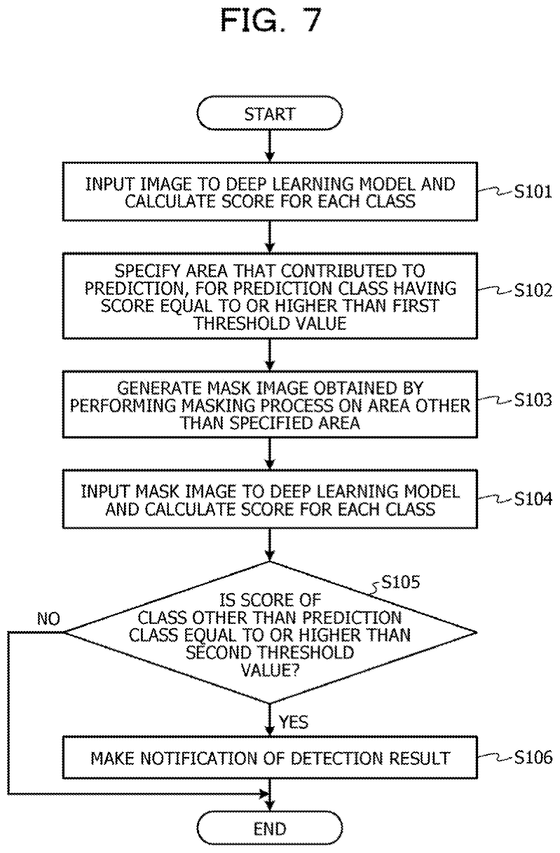

The processing flow of the detection device 10 will be described with reference to FIG. 7. FIG. 7 is a flowchart illustrating a processing flow of the detection device. As illustrated in FIG. 7, first, the detection device 10 inputs an image to the deep learning model and calculates the score for each class (step S101). Next, the detection device 10 specifies an area that contributed to the prediction, for a prediction class having a score equal to or higher than the first threshold value among classes (step S102). Then, the detection device 10 generates a mask image obtained by performing the masking process on an area other than the specified area (step S103).

Furthermore, the detection device 10 inputs the mask image to the deep learning model and calculates the score for each class (step S104). Here, the detection device 10 determines whether or not the score of a class other than the prediction class is equal to or higher than the second threshold value (step S105). When there is a class whose score is equal to or higher than the second threshold value (step S105, Yes), the detection device 10 makes a notification of the detection result (step S106). On the other hand, when there is no class whose score is equal to or higher than the second threshold value (step S105, No), the detection device 10 ends the process without making a notification of the detection result.

[Effects]

As described above, the specification unit 152 specifies, from the input image 201, an area that contributed to the calculation of the score of the first class among scores for each class obtained by inputting the input image 201 to the deep learning model. The generation unit 153 generates a mask image in which an area other than the area specified by the specification unit 152 is masked in the input image 201. The acquisition unit 154 acquires the scores obtained by inputting the mask image to the deep learning model. Here, bias in the teacher data appears in the scores acquired by the acquisition unit 154. For example, when the mask image is input to the deep learning model and the score is calculated, a class that is a class other than the prediction class and in which the teacher data is biased is supposed to have a high score. Therefore, according to the detection device 10, bias in the teacher data may be detected with a small number of man-hours.

The detection unit 155 detects the second class which is a class different from the first class and whose score acquired by the acquisition unit 154 is equal to or higher than the first threshold value. When the teacher data is not biased, a class other than the first class when the mask image is input to the deep learning model is considered to have a very low score. Conversely, when the score of a class other than the first class is high to some extent, it is considered that the teacher data is biased. Therefore, by providing the second threshold value, the detection device 10 may detect the second class in which the teacher data is biased with a small number of man-hours.

By making the pixel values of pixels in an area other than the area specified by the specification unit 152 the same, the generation unit 153 masks the corresponding area. An area where the pixel values are uniform is considered to have a small influence on the score calculation. Therefore, the detection device 10 may reduce the influence on the calculation of the score of the masked area and improve the detection accuracy for bias in the teacher data.

The specification unit 152 specifies the area that contributed to the calculation of the score of the first class on the basis of the contribution obtained by Grad-CAM. As a result, the detection device 10 may specify an area having a high contribution, using an existing approach.

The specification unit 152 specifies an area whose score for each class obtained by inputting the input image 201 to the deep learning model is equal to or higher than the second threshold value and which contributed to the calculation of the score of the first class. It is considered that the influence of bias in the teacher data will appear more clearly in a class having a higher score. Therefore, the detection device 10 may efficiently perform detection by specifying the first class by the threshold value.

In the above embodiment, the description has been made assuming that the detection device 10 calculates the score using the deep learning model. Meanwhile, the detection device 10 may also receive the input image and the calculated scores for each class from another device. In that case, the detection device 10 generates the mask image and detects a class having data bias based on the scores.

In addition, the method for the masking process by the detection device 10 is not limited to the method described in the above embodiment. The detection device 10 may also color the area to be masked in a single color of gray between black and white or may also replace the area to be masked with a predetermined pattern according to the feature of the input image or the prediction class.

[System]

Pieces of information including a processing procedure, a control procedure, a specific name, various types of data, and parameters described above or illustrated in the drawings may be optionally changed unless otherwise stated. In addition, the specific examples, distributions, numerical values, and the like described in the embodiments are merely examples and may be changed in any ways.

Furthermore, each component of each device illustrated in the drawings is functionally conceptual and does not necessarily have to be physically configured as illustrated in the drawings. For example, specific forms of distribution and integration of each device are not limited to those illustrated in the drawings. For example, all or a part of the devices may be configured by being functionally or physically distributed and integrated in optional units according to various types of loads, usage situations, or the like. Moreover, all or any part of individual processing functions performed in each device may be implemented by a central processing unit (CPU) and a program analyzed and executed by the corresponding CPU, or may be implemented as hardware by wired logic.

[Hardware]

FIG. 7 is a diagram explaining a hardware configuration example. As illustrated in FIG. 7, the detection device 10 includes a communication interface 10a, a hard disk drive (HDD) 10b, a memory 10c, and a processor 10d. In addition, the respective units illustrated in FIG. 7 are interconnected by a bus or the like.

The communication interface 10a is a network interface card or the like and communicates with another server. The HDD 10b stores programs and databases (DBs) for operating the functions illustrated in FIG. 2.

The processor 10d is a hardware circuit that reads a program that executes processing similar to the processing of each processing unit illustrated in FIG. 1 from the HDD 10b or the like and loads the read program into the memory 10c, thereby operating a process that executes each function described with reference to FIG. 1 or the like. For example, this process executes a function similar to the function of each processing unit included in the detection device 10. For example, the processor 10d reads a program having functions similar to the functions of the calculation unit 151, the specification unit 152, the generation unit 153, the acquisition unit 154, the detection unit 155, and the notification unit 156 from the HDD 10b or the like. Then, the processor 10d executes a process that executes processing similar to the processing of the calculation unit 151, the specification unit 152, the generation unit 153, the acquisition unit 154, the detection unit 155, the notification unit 156, and the like.

In this manner, the detection device 10 operates as an information processing device that executes a learning classification method by reading and executing the program. Furthermore, the detection device 10 may also implement functions similar to the functions of the embodiments described above by reading the program described above from a recording medium by a medium reading device and executing the read program described above. Note that other programs referred to in the embodiments are not limited to being executed by the detection device 10. For example, the present embodiments may be similarly applied to a case where another computer or server executes the program or a case where such computer and server cooperatively execute the program.

This program may be distributed via a network such as the Internet. Furthermore, this program may be recorded on a computer-readable recording medium such as a hard disk, flexible disk (FD), compact disc read only memory (CD-ROM), magneto-optical disk (MO), or digital versatile disc (DVD) and may be executed by being read from the recording medium by a computer.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A computer-implemented detection method comprising:
specifying, from a first image, an area that contributed to calculation of one of scores for a first class among the scores for each class obtained by inputting the first image to a deep learning model;
generating a second image in which the area other than the area specified by the specifying is masked in the first image; and
acquiring the scores obtained by inputting the second image to the deep learning model.

2. The detection method according to claim 1, which is executed by the computer and further comprises
detecting a second class which is a class different from the first class and for which another one of the scores acquired by the acquiring is equal to or higher than a first threshold value.

3. The detection method according to claim 1, wherein the generating includes making pixel values of pixels in the area other than the area specified by the specifying same to mask the corresponding area.

4. The detection method according to claim 1, wherein the specifying includes specifying the area that contributed to the calculation of the one of the scores for the first class on a basis of a contribution obtained by gradient-weighted class activation mapping (Grad-CAM).

5. The detection method according to claim 1, wherein the specifying includes specifying the area that contributed to the calculation of the one of the scores for the first class for which the one of the scores obtained by inputting the first image to the deep learning model is equal to or higher than a second threshold value.

6. A non-transitory computer-readable storage medium storing a detection program for causing a computer to perform processing, the processing comprises:
specifying, from a first image, an area that contributed to calculation of one of scores for a first class among the scores for each class obtained by inputting the first image to a deep learning model;
generating a second image in which the area other than the area specified by the specifying is masked in the first image; and
acquiring the scores obtained by inputting the second image to the deep learning model.

7. A detection apparatus comprising:
a memory; and
a processor coupled to the memory, the processor being configured to perform processing, the processing including:
specifying, from a first image, an area that contributed to calculation of one of scores for a first class among the scores for each class obtained by inputting the first image to a deep learning model;
generating a second image in which the area other than the area specified by the specifying is masked in the first image; and
acquiring the scores obtained by inputting the second image to the deep learning model.
